(19) United States
(12) Patent Application Publication
(10) Pub. No.: US 2025/0161902 A1
(43) Pub. Date: May 22, 2025

(54) VALVE ASSEMBLY AND FEEDSTOCK REACTOR WITH A VALVE ASSEMBLY

(71) Applicant: EKONA POWER INC., Burnaby (CA)

(72) Inventor: Milo Del Bigio, Burnaby (CA)

(21) Appl. No.: 18/952,652

(22) Filed: Nov. 19, 2024

Related U.S. Application Data
(60) Provisional application No. 63/600,846, filed on Nov. 20, 2023.

(51) Int. Cl. B01J 19/00

(52) U.S. Cl. CPC B01J 19/0053; B01J 2219/00164

(57) ABSTRACT

A valve assembly includes a valve movable between an open position for allowing a fluid to flow through a conduit, and a closed position for preventing the fluid from flowing through the conduit. The valve assembly also includes a rotator engaged with the valve and configured to cause rotation of the valve in response to movement of the valve between the open and closed positions.

### CROSS-REFERENCE TO RELATED APPLICATION

This application claims priority from U.S. Provisional Patent Application Ser. No. 63/600,846 filed on Nov. 20, 2023, the entire disclosures of which are part of the disclosure of the present application and are hereby incorporated by reference in their entireties.

### FIELD

The present disclosure relates to thermal pyrolysis and in particular to a valve assembly and a feedstock reactor with a valve assembly.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Pyrolysis may be achieved by bringing the feedstock gas into thermal contact with a hot fluid. In one example, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

In a known feedstock reactor, feedstock is delivered to a reaction chamber connected to a combustion chamber, and fuel and an oxidant are delivered to the combustion chamber in which the combustion occurs. In a constant-volume process in which the reaction chamber and combustion chamber are sealed prior to combustion, valving is typically used to controllably deliver the feedstock to the reaction chamber, and the fuel and the oxidant to the combustion chamber. The valving is also used to depressurize the reaction chamber once the pyrolysis is complete, in order to extract the reaction products from the reaction chamber.

In use, it is important for the valves to seal properly. Improper sealing may lead to leakage of the fuel, oxidant, and/or feedstock and may negatively impact the efficiency of the pyrolysis. Improper sealing may occur when debris (for example, from the lining of the reaction chamber) clogs the valves and keeps them from closing fully. While using relatively soft valve seats may assist in providing a better seal, a soft valve seat typically requires a polymer material which cannot withstand the pressures or temperatures of pyrolysis. In addition, the use of filters in front of the valves, to reduce the flow of contaminants, may lead to a substantial pressure drop and, again, reduce the effectiveness of the pyrolysis.

### SUMMARY

According to a first aspect of the disclosure, there is provided a valve assembly comprising: a valve movable between: an open position for allowing a fluid to flow through a conduit; and a closed position for preventing the fluid from flowing through the conduit; and a rotator engaged with the valve and configured to cause rotation of the valve in response to movement of the valve between the open and closed positions.

The valve may be a poppet valve.

The rotator may be fixed relative to the valve.

The valve may comprise a groove, and at least a portion of the rotator may be received in the groove.

The groove may be shaped such that: in response to movement of the valve from the open or the closed position to the other of the open and the closed position, the valve is rotated by the rotator in a first direction; and in response to movement of the valve from the other of the open and the closed position back to the open or the closed position, the valve is further rotated by the rotator in the first direction.

The groove may be shaped such that: during a first actuation cycle, and in response to movement of the valve from the open position to the closed position, the valve is rotated by the rotator in a first direction; and during a second actuation cycle that follows the first actuation cycle, in response to movement of the valve from the open position to the closed position, the valve is further rotated by the rotator in the first direction.

The groove may be shaped such that: during a first actuation cycle, and in response to movement of the valve from the closed position to the open position, the valve is rotated by the rotator in a first direction; and during a second actuation cycle that follows the first actuation cycle, in response to movement of the valve from the closed position to the open position, the valve is further rotated by the rotator in the first direction.

The groove may have a variable depth.

The at least a portion of the rotator may be resiliently biased to be received in the groove.

The groove may comprise a first groove portion that is curved and that intersects a second groove portion that is straight.

The valve assembly may further comprise a valve seat, and the valve may further comprise: a valve head for contacting the valve seat when the valve is in the closed position; and a stem connected to the valve head and in which is formed the groove.

The valve assembly may further comprise a valve seat. In the open position, the valve may be spaced from the valve seat, and, in the closed position, the valve may be in contact with the valve seat. One or both of the valve and the valve seat may comprise an irregular surface for decreasing, when the valve is in contact with the valve seat, a surface area that is susceptible to trapping particles between the valve and the valve seat when the valve is in the closed position.

The irregular surface may comprise one or more valleys for receiving the particles and one or more ridges for contacting the valve or the valve seat when the valve is in the closed position.

The valve seat may comprise the irregular surface.

The valve may be translatable between the open and closed positions by translating along a longitudinal axis defined by the valve.

According to a further aspect of the disclosure, there is provided a feedstock reactor comprising: a reaction chamber for receiving feedstock; a combustion chamber connected to the feedstock chamber and for receiving a fuel and an oxidant; a valve assembly for controlling flow of a fluid comprising one or both of the fuel and the oxidant to the combustion chamber; and one or more igniters for triggering combustion of the fuel in the combustion chamber, in the presence of the oxidant, wherein, as a result of the combustion, combustion products are formed, flow into the reaction chamber, mix with the feedstock, and thereby decompose the feedstock, wherein the valve assembly comprises: a valve movable between: an open position for allowing the fluid to flow into the combustion chamber; and a closed position for preventing the fluid from flowing into the combustion chamber; and a rotator engaged with the valve and configured to cause rotation of the valve in response to movement of the valve between the open and closed positions.

The valve assembly may further comprise a valve seat. In the open position, the valve may be spaced from the valve seat, and, in the closed position, the valve may be in contact with the valve seat. One or both of the valve and the valve seat may comprise an irregular surface for decreasing, when the valve is in contact with the valve seat, a surface area that is susceptible to trapping particles between the valve and the valve seat when the valve is in the closed position.

The irregular surface may comprise one or more valleys for receiving the particles and one or more ridges for contacting the valve or the valve seat when the valve is in the closed position.

According to a further aspect of the disclosure, there is provided a method of operating a feedstock reactor comprising a reaction chamber connected to a combustion chamber, the method comprising: loading the reaction chamber with feedstock; loading the combustion chamber with a fuel and an oxidant, comprising: translating a valve from a closed position to an open position and then back to the closed position, wherein: in the closed position, a fluid comprising one or both of the fuel and the oxidant is prevented from flowing into the combustion chamber; and in the open position, loading the combustion chamber comprises flowing the fluid into the combustion chamber; and during the translating, rotating the valve; and combusting the fuel in the combustion chamber, in the presence of the oxidant, wherein, as a result of the combustion, combustion products are formed, flow into the reaction chamber, mix with the feedstock, and thereby decompose the feedstock.

According to a further aspect of the disclosure, there is provided a method of operating a valve, comprising: translating the valve from a closed position to an open position and then back to the closed position, wherein: in the closed position, a fluid is prevented from flowing through a conduit; and in the open position, the method further comprises flowing the fluid through the conduit; and during the translating, rotating the valve.

This summary does not necessarily describe the entire scope of all aspects. Other aspects, features and advantages will be apparent to those of ordinary skill in the art upon review of the following description of specific embodiments.

### BRIEF DESCRIPTION OF DRAWINGS

Embodiments of the disclosure will now be described in detail in conjunction with the accompanying drawings of which:

FIG. 1 is a schematic diagram of a feedstock reactor according to an embodiment of the disclosure;

FIGS. 2A and 2B are schematic diagrams showing a valve in respective open and closed positions, wherein in the closed position particles prevent proper closing of the valve;

FIGS. 3A and 3B are schematic diagrams showing a valve in respective open and closed positions, and a valve seat with an irregular surface, according to an embodiment of the disclosure;

FIGS. 4A and 4B show respectively a poppet valve with a grooved stem, and a rotator engaged with the poppet valve, according to an embodiment of the disclosure; and

FIG. 5 shows a poppet valve integrated in a feedstock reactor, according to an embodiment of the disclosure.

### DETAILED DESCRIPTION

The present disclosure seeks to provide a novel valve assembly and a feedstock reactor having such a valve assembly. While various embodiments of the disclosure are described below, the disclosure is not limited to these embodiments, and variations of these embodiments may well fall within the scope of the disclosure which is to be limited only by the appended claims.

Generally, embodiments of the disclosure relate to methods and systems for performing pyrolysis of a feedstock gas, such as natural gas or a hydrocarbon gas, such as methane. Examples of such methods of pyrolysis, as well as example feedstock gas reactors that may be used for such pyrolysis, are described in further detail in Patent Cooperation Treaty (PCT) Publication No. WO 2020/118417, herein incorporated by reference in its entirety.

Generally, according to embodiments of the disclosure, a valve assembly comprises a valve movable between an open position for allowing a fluid to flow through a conduit, and a closed position for preventing the fluid from flowing through the conduit. A rotator is engaged with the valve and configured to cause rotation of the valve in response to movement of the valve between the open and closed positions.

Therefore, during opening and closing of the valve, the valve is rotated. This may assist in providing a good seal between the valve and the valve seat against which the valve seals. For example, rotation of the valve may assist in dislodging particles that become trapped between the valve and the valve seat when the valve is in the closed position. Furthermore, rotation of the valve may assist in promoting more even wear of the valve. In particular, every time the valve contacts the valve seat, the valve may have rotated to a different position, and therefore, for every cycle of valve movement, a different portion of the valve may be in contact with a given portion of the valve seat.

According to some embodiments, the valve assembly further comprises the valve seat. In the open position, the valve is spaced from the valve seat, and, in the closed position the valve is in contact with the valve seat. One or both of the valve and the valve seat may comprise an irregular surface for decreasing, when the valve is in contact with the valve seat, a surface area that is susceptible to trapping particles between the valve and the valve seat when the valve is in the closed position.

Therefore, the irregular surface may improve the sealing between the valve and the valve seat. For example, the irregular surface may comprise one or more valleys (such as recesses or pockets) for receiving the particles, and one or more ridges for contacting the valve or the valve seat when the valve is in the closed position. Therefore, the ridges may provide a seal between the valve and the valve seat while the valleys may trap particles between the valve and the valve seat in recessed positions such that the particles do not interfere with the seal provided by the ridges.

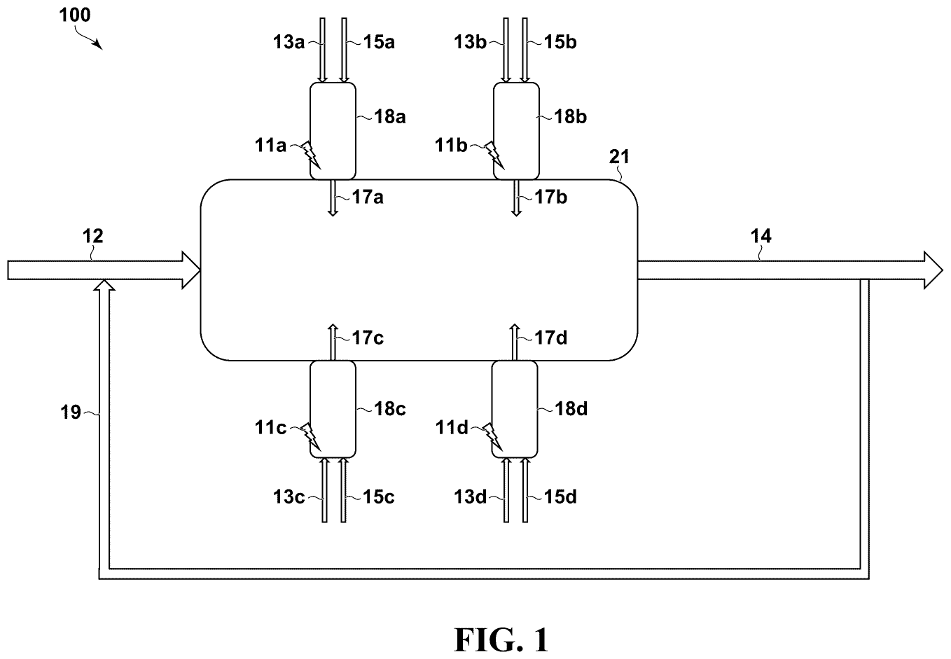

Turning to FIG. 1, there is shown an embodiment of a feedstock reactor 100 used to decompose feedstock, according to an embodiment of the disclosure.

Reactor 100 includes a reaction chamber 21 connected to multiple combustors 18a-18d (which collectively may be referred to as combustors 18). Each combustor 18 includes a combustion chamber into which is fed an oxidant 13a-13d (for example, pure oxygen or air) and a fuel 15a-15d (for example, unreacted feedstock). Each combustor 18 further includes an igniter 11a-11a for triggering combustion of the fuel and the oxidant within the combustion chamber.

During a reaction cycle of reactor 100, a feedstock 12 (such as a hydrocarbon, for example methane) is fed under pressure into reaction chamber 21. At the same time, combustors 18a-18d are filled with a combustible gas mixture comprising a mixture of fuel 15a-d (e.g., methane or natural gas) and oxidant 13a-d. Once reaction chamber 21 and combustors 18 have been loaded with feedstock and combustible gas mixture, respectively, igniters 11a-d are triggered and cause combustion of the combustible gas mixture in combustors 18 which results in the generation of hot combustion products 17a-d. Combustion products 17a-d flow under pressure into the interior volume of reaction chamber 21 and mix with the feedstock within reaction chamber 21.

As a result of the flow of combustion products 17a-d into reaction chamber 21, thermal energy is transferred from combustion products 17a-d to the feedstock. Energy is also transferred from combustion products 17a-d to the feedstock via dynamic compression of the feedstock as a result of the pressure increasing within reaction chamber 21 in response to the flow of hot, pressurized combustion products into reaction chamber 21. Past a certain point, the increase in the temperature of the feedstock is sufficient to drive decomposition or pyrolysis of the feedstock. In the case of methane, for example, the decomposition takes the following form:

CH₄+energy→C+2H₂

The pyrolysis reaction generates reaction products 14 that are extracted from reaction chamber 21 by depressurizing reaction chamber 21. A portion of reaction products 14 is recycled back to reaction chamber 21 for future reaction cycles. In the case of methane pyrolysis: reaction products 14 may comprise one or more of hydrogen, nitrogen, and carbon; the unwanted products are primarily carbon dioxide, nitrogen, and water; and the recycled gas mixture comprises primarily unreacted natural gas, hydrogen, nitrogen, and carbon monoxide.

Valve assemblies may be used to controllably deliver fuel 15a-d and oxidant 13a-d to combustors 18a-18d, as well as feedstock 12 to reaction chamber 21. A valve assembly may also be used to extract reaction products 14 from reaction chamber 21. Examples of such valve assemblies are described below, according to embodiments of the disclosure.

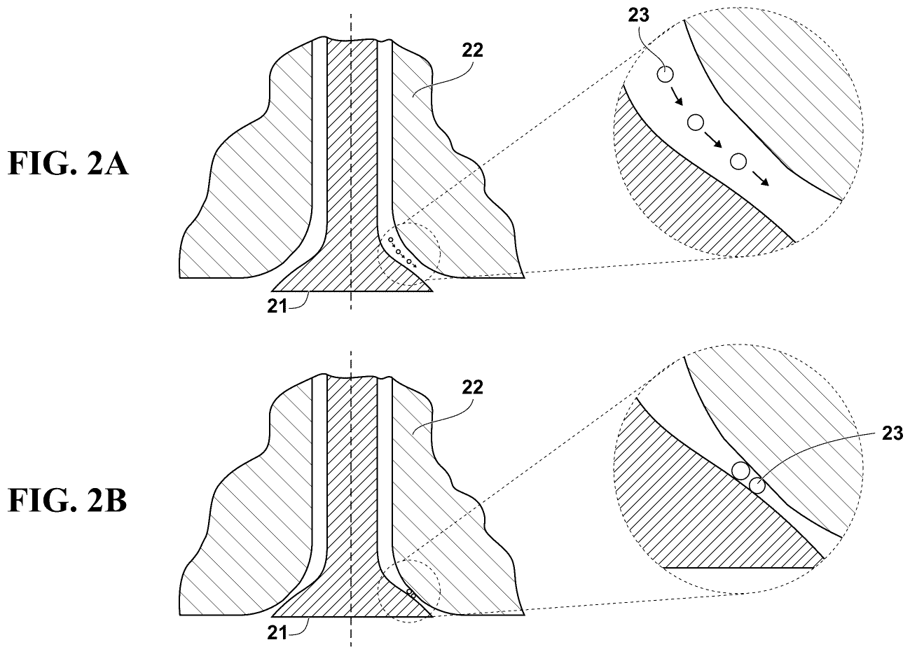

Turning to FIG. 2A, there is shown a valve 21 in an open position relative to a valve seat 22. As can be seen, debris/particles are entrained in the flow of fluid between valve 21 and valve seat 22. Turning now to FIG. 2B, valve 21 is shown in the closed position relative to valve seat 22. Instead of valve 21 forming a flush seal with valve seat 22, particles 23 have become trapped between valve 21 and valve seat 22, compromising the seal.

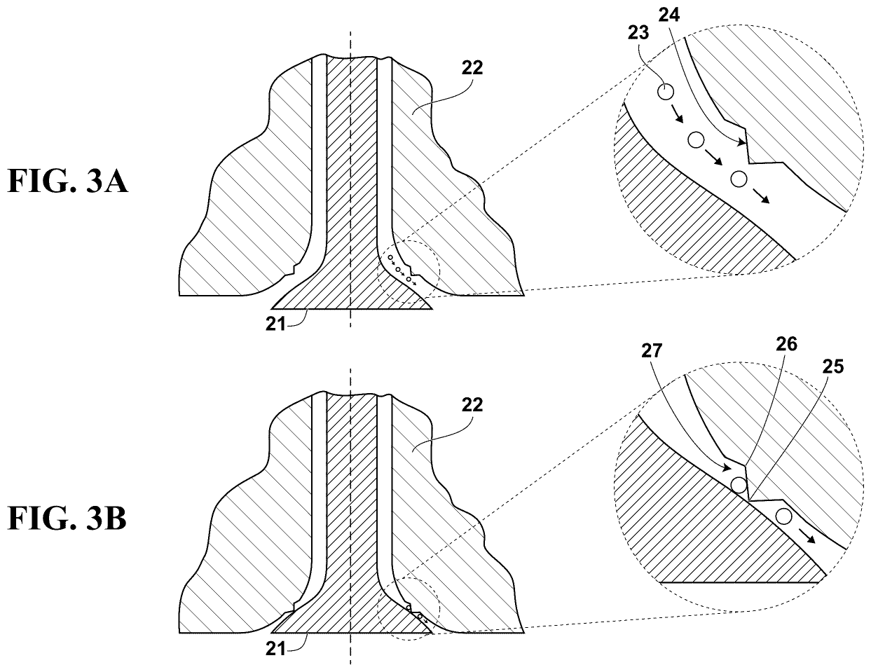

According to embodiments of the disclosure, and referring now to FIGS. 3A and 3B, one, or both of, valve 21 and valve seat 22 may comprise an irregular surface to improve the seal between valve 21 and valve seat 22 when valve 21 is in the closed position. As can be seen in FIG. 3A, there is shown valve 21 in the open position relative to valve seat 22. As before, debris/particles (such as solid carbon and/or particles from the lining of the reaction chamber) are entrained in the flow of fluid between valve 21 and valve seat 22. In this case, valve seat 22 comprises an irregular surface 24 that contacts valve 21 when valve 21 is in the closed position. Irregular surface 24 includes one or more ridges 25 between one or more valleys 26.

Referring now to FIG. 3B, when valve 21 is in the closed position, ridges 25 of irregular surface 24 contact valve 21 to provide a seal between valve 21 and valve seat 22. Meanwhile, valleys 26 define pockets or recesses 27 that trap particles 23 between valve 21 and valve seat 22. Because of the recessed nature of pockets 27, particles are prevented from compromising the seal between valve 21 and valve seat 22. The steepness of ridges 25 may be increased to accentuate the depth of valleys 26 and thereby improve the quality of the seal provided by irregular surface 24. Ridges 25 should preferably not be too steep such that they risk being flattened when valve 21 is moved to the closed position. As can be seen, irregular surface 24 effectively decreases the surface area available for debris to become stuck between valve 21 and valve seat 22.

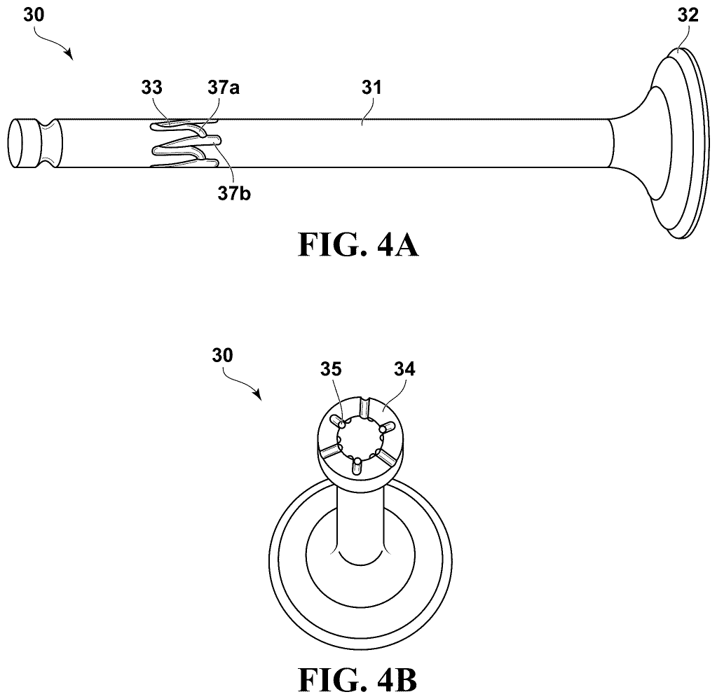

Turning now to FIG. 4A, there is shown a poppet valve 30 according to an embodiment of the disclosure. Poppet valve 30 comprises a valve stem 31 connected to a valve head 32. Within valve stem 31 is formed a configuration of one or more grooves (for simplicity, “groove 33”). FIG. 4B shows a rotator 34 engaged with groove 33. In particular, rotator 34 includes a number of rollers 35 that are positioned within groove 33. As poppet valve 30 is actuated, rollers 35 force poppet valve 30 to rotate about its longitudinal axis because of the curved nature of groove 33. The degree of rotation will depend on the configuration of groove 33. Preferably, the amount of angular rotation for every cycle of valve actuation (i.e., every cycle of movement of valve 30 between its open and closed positions) is equal to a number of degrees that is not a factor of 360 degrees. As a result, for every cycle of valve actuation, each portion of valve head 32 is prevented from contacting the same portion of the valve seat that was contacted in the previous cycle. This may reduce wear on valve head 32 over many cycles of valve actuation.

Furthermore, groove 33 may be shaped such for, for each successive actuation of poppet valve 30, poppet valve 30 is always rotated in the same direction. For example, according to some embodiments, groove 33 may be separated into groove segments that promote unidirectional rotation. For example, the groove segments may include an actuation portion. Both portions may have variable depths, and in particular may be deeper at one end and shallower at the other end. At the start of the actuation portion, a roller 35 (which may be spring-biased) may be in the deeper end of the groove. As poppet valve 30 actuates, the groove that roller 35 sits in becomes shallower, until roller 35 arrives at a point where the actuation portion intersects with the return portion. Once roller 35 enters the return portion, the spring is able to relax, which prevents roller 35 from re-entering (i.e., retracing) the actuation portion. The same mechanism may be used on the return portion.

A second method of preventing groove retracing is through proper shaping of groove 33. Poppet valve 30 generally does not rotate without a biasing force. Therefore, the actuation portions and return portions may be configured to intersect such that, at the intersection point, either the actuation portion or the return portion is straight while the other portion is curved. As a result, roller 35 is more likely to follow the straight path. For instance, as can be seen in FIG. 4A, the end of actuation portion 37a is curved just before meeting return portion 37b which is initially straight.

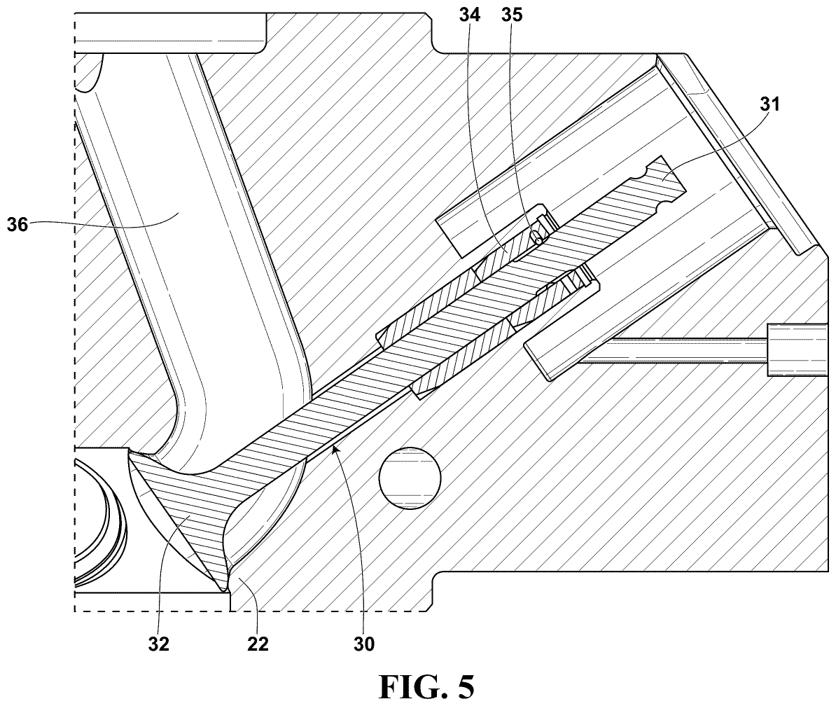

Turning to FIG. 5, there is shown poppet valve 30 integrated into a feedstock gas reactor, such as reactor 100 described in FIG. 1. Poppet valve 30 is in its closed position, preventing the flow of fluid through a conduit 36. Conduit 36 may be a conduit that is configured to permit the flow of a fuel or an oxidant into a combustion chamber. Alternatively, conduit 36 may be a conduit that is configured to permit the flow of feedstock into the reaction chamber, or reaction products out of the reaction chamber.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A valve assembly comprising:
a valve movable between:
an open position for allowing a fluid to flow through a conduit; and
a closed position for preventing the fluid from flowing through the conduit; and
a rotator engaged with the valve and configured to cause rotation of the valve in response to movement of the valve between the open and closed positions.

2. The valve assembly of claim 1, wherein the valve is a poppet valve.

3. The valve assembly of claim 1, wherein the rotator is fixed relative to the valve.

4. The valve assembly of claim 1, wherein:
the valve comprises a groove; and
at least a portion of the rotator is received in the groove.

5. The valve assembly of claim 4, wherein the groove is shaped such that:
in response to movement of the valve from the open or the closed position to the other of the open and the closed position, the valve is rotated by the rotator in a first direction; and
in response to movement of the valve from the other of the open and the closed position back to the open or the closed position, the valve is further rotated by the rotator in the first direction.

6. The valve assembly of claim 4, wherein the groove is shaped such that:
during a first actuation cycle, and in response to movement of the valve from the open position to the closed position, the valve is rotated by the rotator in a first direction; and
during a second actuation cycle that follows the first actuation cycle, in response to movement of the valve from the open position to the closed position, the valve is further rotated by the rotator in the first direction.

7. The valve assembly of claim 4, wherein the groove is shaped such that:
during a first actuation cycle, and in response to movement of the valve from the closed position to the open position, the valve is rotated by the rotator in a first direction; and
during a second actuation cycle that follows the first actuation cycle, in response to movement of the valve from the closed position to the open position, the valve is further rotated by the rotator in the first direction.

8. The valve assembly of claim 4, wherein the groove has a variable depth.

9. The valve assembly of claim 4, wherein the at least a portion of the rotator is resiliently biased to be received in the groove.

10. The valve assembly of claim 4, wherein the groove comprises a first groove portion that is curved and that intersects a second groove portion that is straight.

11. The valve assembly of claim 4, wherein:
the valve assembly further comprises a valve seat; and
the valve further comprises:
a valve head for contacting the valve seat when the valve is in the closed position; and
a stem connected to the valve head and in which is formed the groove.

12. The valve assembly of claim 1, wherein:
the valve assembly further comprises a valve seat, wherein:
in the open position the valve is spaced from the valve seat; and
in the closed position the valve is in contact with the valve seat; and
one or both of the valve and the valve seat comprise an irregular surface for decreasing, when the valve is in contact with the valve seat, a surface area that is susceptible to trapping particles between the valve and the valve seat when the valve is in the closed position.

13. The valve assembly of claim 12, wherein the irregular surface comprises one or more valleys for receiving the particles and one or more ridges for contacting the valve or the valve seat when the valve is in the closed position.

14. The valve assembly of claim 12, wherein the valve seat comprises the irregular surface.

15. The valve assembly of claim 1, wherein the valve is translatable between the open and closed positions by translating along a longitudinal axis defined by the valve.

16. A feedstock reactor comprising:
a reaction chamber for receiving feedstock;
a combustion chamber connected to the feedstock chamber and for receiving a fuel and an oxidant;
a valve assembly for controlling flow of a fluid comprising one or both of the fuel and the oxidant to the combustion chamber; and
one or more igniters for triggering combustion of the fuel in the combustion chamber, in the presence of the oxidant, wherein, as a result of the combustion, combustion products are formed, flow into the reaction chamber, mix with the feedstock, and thereby decompose the feedstock,
wherein the valve assembly comprises:
a valve movable between:
an open position for allowing the fluid to flow into the combustion chamber; and
a closed position for preventing the fluid from flowing into the combustion chamber; and
a rotator engaged with the valve and configured to cause rotation of the valve in response to movement of the valve between the open and closed positions.

17. The feedstock reactor of claim 16, wherein:
the valve assembly further comprises a valve seat, wherein:
in the open position the valve is spaced from the valve seat; and
in the closed position the valve is in contact with the valve seat; and
one or both of the valve and the valve seat comprise an irregular surface for decreasing, when the valve is in contact with the valve seat, a surface area that is susceptible to trapping particles between the valve and the valve seat when the valve is in the closed position.

18. The feedstock reactor of claim 17, wherein the irregular surface comprises one or more valleys for receiving the particles and one or more ridges for contacting the valve or the valve seat when the valve is in the closed position.

19. A method of operating a feedstock reactor comprising a reaction chamber connected to a combustion chamber, the method comprising:
loading the reaction chamber with feedstock;
loading the combustion chamber with a fuel and an oxidant, comprising:
translating a valve from a closed position to an open position and then back to the closed position, wherein:
in the closed position, a fluid comprising one or both of the fuel and the oxidant is prevented from flowing into the combustion chamber; and
in the open position, loading the combustion chamber comprises flowing the fluid into the combustion chamber; and
during the translating, rotating the valve; and
combusting the fuel in the combustion chamber, in the presence of the oxidant, wherein, as a result of the combustion, combustion products are formed, flow into the reaction chamber, mix with the feedstock, and thereby decompose the feedstock.

20. A method of operating a valve, comprising:
translating the valve from a closed position to an open position and then back to the closed position, wherein:
in the closed position, a fluid is prevented from flowing through a conduit; and
in the open position, the method further comprises flowing the fluid through the conduit; and
during the translating, rotating the valve.
